(19) United States
(12) Patent Application Publication
(10) Pub. No.: US 2012/0118322 A1
(43) Pub. Date: May 17, 2012

(54) FLOW-THROUGH WASHING METHOD AND FLOW-THROUGH WASHING APPARATUS

(75) Inventors: Ryuji Sakaguchi, Chiba-shi (JP); Norio Oshima, Ichihara-shi (JP); Zhipeng Wang, Oyama-shi (JP); Ryo Tanaka, Ichihara-shi (JP)

(73) Assignee: Showa Denko K.K., Minato-ku, Tokyo (JP)

(21) Appl. No.: 13/320,400

(22) PCT Filed: May 14, 2010
(86) PCT No.: PCT/JP2010/003269

§ 371 Date: Jan. 30, 2012

(30) Foreign Application Priority Data
May 15, 2009 (JP) 2009-119003

(51) Int. Cl. B08B 7/04; B08B 7/02; B08B 3/02

(52) U.S. Cl. 134/10; 134/25.1; 134/198

(57) ABSTRACT

Disclosed are a flow-through washing method and a flow-through washing apparatus which efficiently remove dust adhering to the surface of a substrate and prevent dust from adhering to the surface of the substrate again after washing. The flow-through washing method runs washing liquid (L) inside a washing tank (2) in the lateral direction, and applies an ultrasonic vibration to the washing liquid (L) in a state in which an object (W) to be washed is immersed in this washing liquid (L), whilst washing this object (W). By regulating the flow rate of the washing liquid (L) flowing in any of the feed ports (3) and/or discharge ports (5) of a plurality of feed ports (3) which feed the washing liquid (L) to the washing tank (2) and plurality of discharge ports (5) which discharge washing liquid (L) from the washing tank (2), the washing liquid (L) inside the washing tank (2) can be set so as to run in a laminar flow state.

### TECHNICAL FIELD

The present invention relates to a flow-through washing method and a flow-through washing apparatus that are preferably used when, for example, substrates for magnetic recording media or magnetic recording media components used in an apparatus for manufacturing a magnetic recording medium, a shield plate of a sputtering apparatus, and the like are washed.

Priority is claimed on Japanese Patent Application No. 2009-119003, filed May 15, 2009, the content of which is incorporated herein by reference.

### BACKGROUND ART

A disk-shaped aluminum substrate, a disk-shaped glass substrate, or the like, which has a center hole, has been used as a substrate for a magnetic recording medium used in, for example, a hard disk drive. Since this substrate for a magnetic recording medium is produced through various surface treatment processes such as a polishing process performed on the surface thereof, a process for removing dust and the like adhering to the surface of the substrate is performed after the surface treatment processes and the like.

Furthermore, as a high recording density of a magnetic recording medium is required, high flatness of the magnetic recording medium is demanded. Meanwhile, an advanced washing technique has been required for removing not only dust and the like adhering to the surface of a substrate for a magnetic recording medium, but also dust and the like adhering to components used in an apparatus for manufacturing a magnetic recording medium, a shield plate of a sputtering apparatus, and the like. Furthermore, in recent years, there have been cases where a wet washing process performed on the surface of a substrate is provided in a process for forming a film on a substrate for a magnetic recording medium.

As a washing apparatus for a substrate for a magnetic recording medium or the like, there has been proposed an apparatus that uses, for example, a magnetic disk substrate or the like as a workpiece, performs surface treatment such as polishing on the surface of the workpiece, uses a plurality of washing tanks, and washes the workpiece using a liquid in each of the washing tanks whilst sequentially conveying the workpiece to a plurality of washing tanks by a conveyor in order to remove foreign materials and the like adhering to the surface of the workpiece (for example, see Patent Document 1).

However, in the washing apparatus disclosed in Patent Document 1, a plurality of rotating brushes, showers, and the like are provided at the washing tanks and scrub cleaning is performed using a rotating brush whilst washing liquid is supplied to each substrate. Since the rotating brush comes into contact with the surface of a substrate, there is a concern that scratches are formed on the surface of the substrate.

For this reason, as a washing method that does not use a rotating brush, there has been proposed, for example, a method of washing a substrate by immersing a holder, which holds the substrate, in the washing liquid in a washing tank whilst supplying washing liquid from the bottom of a washing tank and making the washing liquid overflow from the upper portion of the washing tank.

However, in the washing method that makes washing liquid flow upward from the lower portion of the washing tank, contaminants including dust and the like, which are removed from the surface of a substrate, are not discharged from the upper portion of the washing tank together with the washing liquid and a part of the contaminants remain in the washing tank. For this reason, stagnation of the washing liquid occurs in the washing tank. In this case, when the holder is lifted from the washing tank, contaminants remaining in the washing liquid stick to the surface of the substrate again.

Meanwhile, there has been proposed a flow-through washing apparatus that washes a substrate by immersing a holder, which holds the substrate, in the washing liquid in the washing tank, whilst making the washing liquid in the washing tank flow in the lateral direction in a laminar flow state (for example, see Patent Document 2 and the like).

In this washing method that makes the washing liquid flows in the lateral direction in a laminar flow state, it is possible to quickly discharge the washing liquid containing contaminants to the outside of the immersion tank. Accordingly, it is possible to prevent contaminants from adhering to the surface of the substrate again.
[Patent Document 1] JP-A-2001-96245
[Patent Document 2] JP-A-9-206708

### DISCLOSURE OF INVENTION

Meanwhile, in the above-mentioned flow-through washing apparatus disclosed in Patent Document 2, a porous rectification plate is provided in a flow passage to prevent contaminants, which are separated from an object to be washed and ride on the turbulent flow of washing liquid, from adhering to the object to be washed again. When the flow of the washing liquid passes through the rectification plate, the flow of the washing liquid is regulated so as to become a uniform flow (laminar flow) without disturbance to the flow of the washing liquid.

However, in this flow-through washing apparatus, the washing liquid flowing in the washing tank forms a laminar flow when an object to be washed is not immersed in the washing tank. Meanwhile, when an object to be washed is immersed in the washing tank, the washing liquid flowing in the washing tank is disturbed by the object to be washed and forms a turbulent flow. Washing performance for the object to be washed deteriorated due to the turbulent flow.

Furthermore, there is a case where ultrasonic vibration is applied to the inside of the washing tank in order to improve the washing performance of the flow-through washing apparatus. However, the laminar flow in the washing tank may be disturbed by this ultrasonic vibration.

Furthermore, the flow-through washing apparatus disclosed in Patent Document 2 has a structure that stores used washing liquid in a reservoir tank and circulates and uses the stored washing liquid. However, in the case of this structure, the washing liquid easily comes into contact with atmosphere. For this reason, there is a case where bubbles are mixed to the washing liquid and adsorbed to the surface of the object to be washed, so that washing performance deteriorates.

Accordingly, the invention has been proposed in consideration of the above-mentioned circumstances, and an object of the invention is to provide a flow-through washing method and a flow-through washing apparatus that efficiently remove dust and the like adhering to the surface of an object to be washed and prevent the dust and the like from adhering to the surface of the object to be washed again after washing.

The inventor has investigated ways to solve the above-mentioned problem. That is, when the washing liquid is made to flow in the lateral direction in a laminar flow state in a washing tank and objects to be washed are washed whilst ultrasonic vibration is applied to the washing liquid in a state where the objects to be washed are immersed in the washing liquid, turbulent flows are generated by the ultrasonic vibration applied to the washing liquid or the objects immersed in the washing tank and contaminants, such as dust or foreign materials, separated from the surfaces of the object to be washed remain, particularly at the upper flows in the washing tank, due to the turbulent flows. The remaining contaminants stick to the surface of the objects to be washed again, so that washing performance for the objects to be washed deteriorates.

It was considered preferable that the washing liquid in the washing tank be made to stably flow in a laminar flow state by regulating the flow rate of the washing liquid flowing through any feed ports and/or discharge ports of a plurality of feed ports through which the washing liquid is supplied to the washing tank and a plurality of discharge ports through which the washing liquid is discharged from the washing tank; the contact between the washing liquid and the atmosphere be suppressed and the mixing of bubbles to the washing liquid is suppressed by employing this washing method; turbulent flows are generated by the displacement of the surface of water, particularly, by the application of ultrasonic vibration to the washing tank but the turbulent flows can be changed to uniform flows (laminar flows) without disturbance; and a space be formed between the inner surface of the washing tank and the object to be washed in the washing tank in the past to stabilize a laminar flow. However, the inventor has found that it is preferable that objects to be washed be closely disposed in the washing tank since turbulent flows are easily generated due to a difference in the resistance of flowing washing liquid that depends on the presence or absence of the objects to be washed in the washing tank, and has completed the invention.

That is, the invention provides the following device.

(1) A flow-through washing method including steps of makes washing liquid flow in the lateral direction in a washing tank, and washes objects to be washed whilst applying ultrasonic vibration to the washing liquid in a state where the objects to be washed are immersed in the washing liquid. The washing liquid in the washing tank flows in a laminar flow state by regulating the flow rate of the washing liquid flowing through any feed port and/or discharge ports of a plurality of feed ports through which the washing liquid is supplied to the washing tank and a plurality of discharge ports through which the washing liquid is discharged from the washing tank.

(2) In the flow-through washing method of (1), ultrasonic vibration is applied from the bottom of the washing tank.

(3) In the flow-through washing method of (1) or (2), when substrates, which are held on a holder as the objects to be washed, are washed, the holder is disposed in the immersion tank so that main surfaces of the substrates are parallel to the flow direction of the washing liquid.

(4) In the flow-through washing method of (3), a plurality of substrates, which are held in line on the holder so as to be parallel to each other, are washed, and the interval between the plurality of substrates held on the holder is reduced to a range where resistance of the washing liquid flowing between the substrates is increased.

(5) In the flow-through washing method of (3) or (4), the shortest distance between the substrate and an inner surface of the washing tank is set to one time or less of a diameter of the substrate.

(6) In the flow-through washing method of any one of (1) to (5), substrates for magnetic recording media or magnetic recording media are washed as the substrates.

(7) In the flow-through washing method of any one of (1) to (6), the washing liquid is cyclically reused.

(8) A flow-through washing apparatus includes a washing tank where objects to be washed are washed, a plurality of feed ports through which washing liquid is supplied to the washing tank, a plurality of discharge ports through which the washing liquid is discharged from the washing tank, and vibration generating device for applying ultrasonic vibration to the washing liquid in the washing tank. The flow-through washing apparatus makes the washing liquid flow in the lateral direction in the washing tank, and washes objects to be washed whilst applying ultrasonic vibration to the washing liquid in a state where the objects to be washed are immersed in the washing liquid. The flow-through washing apparatus includes flow rate regulating device for regulating the flow rate of the washing liquid flowing through any feed ports and/or the discharge ports.

(9) In the flow-through washing apparatus of (8), the vibration generating device is disposed on the bottom of the washing tank.

(10) The flow-through washing apparatus of (8) or (9) further includes a device that circulates the washing liquid.

As described above, according to the invention, it is possible to provide a flow-through washing method and a flow-through washing apparatus with high washing performance that efficiently remove contaminants, such as dust or foreign materials, adhering to the surface of an object to be washed and prevent these pollutant from adhering to the surface of the object to be washed again after washing.

### BRIEF DESCRIPTION OF THE DRAWINGS

FIG. 1 is a plan view showing the configuration of a flow-through washing apparatus to which the invention is applied.

FIG. 2 is a cross-sectional view showing the configuration of the flow-through washing apparatus to which the invention is applied.

FIG. 3 is a cross-sectional view illustrating turbulent flows that are generated in a washing tank.

FIG. 4 is a plan view illustrating turbulent flows that are generated in a washing tank.

### DESCRIPTION OF EMBODIMENTS

A flow-through washing method and a flow-through washing apparatus to which the invention is applied will be described in detail below with reference to the drawings. Meanwhile, since drawings, which are used in the following description, may schematically show characteristic portions for convenience to ease the understanding of the characteristics, the dimension ratio of each portion may not equal the actual dimension ratio thereof.

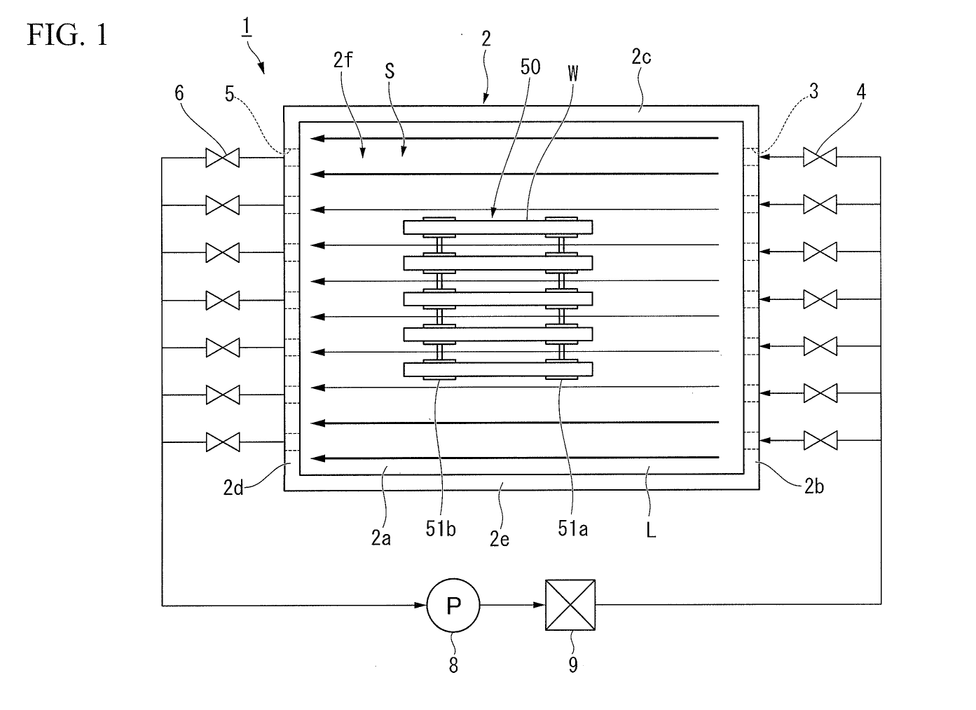

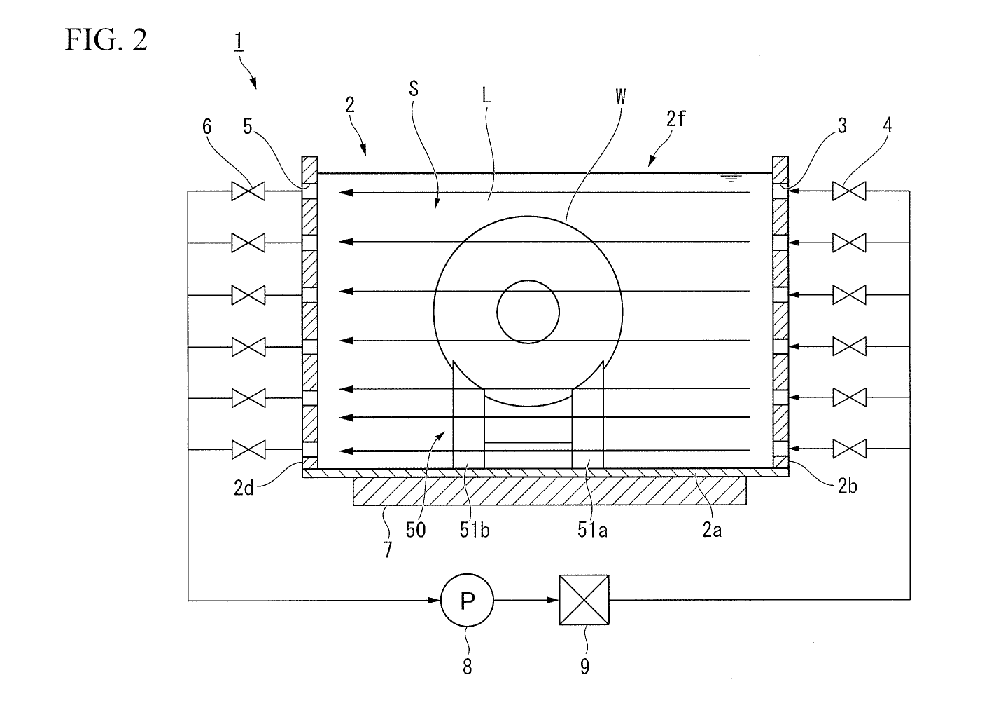

A case where a substrate W (an object to be washed) for a magnetic recording medium to be mounted on a hard disk drive is washed by, for example, a flow-through washing apparatus 1 shown in FIGS. 1 and 2 to which the invention is applied will be described in this embodiment by way of example.

Meanwhile, pure water is basically used as washing liquid L that is used to wash the substrate W. However, a treated water or the like, which has been subjected to chemical treatment or the like, may be used other than pure water. Specifically, examples of the washing liquid L may include an organic solvent such as isopropyl alcohol, a liquid chemical detergent including a surfactant, anode water, cathode water, an acidic solution or an alkaline solution diluted with pure water to a low concentration, ozone water or hydrogen water, and the like, other than pure water and ultrapure water. Furthermore, these examples of washing liquid L may be appropriately selected and used according to a substrate W to be washed (an object to be washed).

As shown in FIGS. 1 and 2, the flow-through washing apparatus 1 to which the invention is applied includes a washing tank 2 where a holder 50 holding substrates W is immersed in the washing liquid L and the substrates W are washed.

A plurality of disk-shaped substrates W each of which includes a center hole are held on the holder 50 so as to be parallel to each other. Furthermore, portions of the outer peripheral portion of each of the substrates W, which correspond to both sides of a center line passing through the center hole of the substrate, are supported by a pair of support plates 51a and 51b provided at the holder 50. Meanwhile, a V-shaped groove portion (not shown) with which the outer peripheral portion of each of the substrates W is engaged is formed at each of the pair of support plates 51a and 51b.

Each of the substrates W is supported by the pair of support plates 51a and 51b, so that the substrates are held on the holder 50 in a vertical state (a state where the main surfaces of the substrates W are parallel to the vertical direction). Furthermore, the holder 50 is disposed on the bottom surface of the washing tank 2 so that the main surface of each of the substrates W is parallel to the flow direction of the washing liquid L. Meanwhile, in this embodiment, about 50 substrates W each of which has a diameter of 3.5 inches are held on the holder 50 in one line at an interval of about 5 mm so as to be parallel to each other.

The washing tank 2 includes a rectangular bottom wall 2a; four side walls 2b, 2c, 2d, and 2e that are erected from the periphery of the bottom wall 2a; and an opening portion 2f that is formed at the upper surface facing the bottom wall 2a. The washing tank 2 is formed in a substantially rectangular parallelepiped shape, and forms a substantially rectangular parallelepiped immersion space S in which the holder 50 is immersed.

Moreover, a plurality of feed ports 3 through which washing liquid L is supplied are formed at the upstream side wall 2b of the washing tank 2. The plurality of feed ports 3 are disposed in line at predetermined intervals in a width direction and a height direction of the side wall 2b. Furthermore, since a flow rate regulating valve (flow rate regulating device) 4 is connected to each of the feed ports 3, it is possible to individually regulate the flow rate of the washing liquid L supplied from the respective feed ports 3 by regulating the openings of the flow rate regulating valves 4.

Furthermore, a plurality of discharges ports 5 through which washing liquid L is discharged are formed at the downstream side wall 2d of the washing tank 2. The plurality of discharge ports 5 are disposed in line at predetermined intervals in a width direction and a height direction of the side wall 2d. Moreover, since a flow rate regulating valve (flow rate regulating device) 6 is connected to each of the discharge ports 5, it is possible to individually regulate the flow rate of the washing liquid L discharged from the respective discharge ports 5 by regulating the openings of the flow rate regulating valves 6.

Meanwhile, in this embodiment, the feed ports 3 and the discharge ports 5 each of which the total number is 42 are formed at the side walls 2b and 2d at the positions, which face each other, in seven lines at an interval of 5 cm in the width direction and in six lines at an interval of 5 cm in the height direction, respectively. However, the disposition, the number, the interval, and the like of the feed ports 3 and the discharge ports 5 may be appropriately changed in embodiments.

Furthermore, an ultrasonic oscillator (ultrasonic wave generating device) 7, which applies ultrasonic vibration to the washing liquid L in the immersion space S2, is provided on the bottom wall 2a of the washing tank 2 in order to improve washing performance for the substrate W. The ultrasonic oscillator 7 applies the ultrasonic vibration, which corresponds to, for example, an output of about 500 W and a frequency of about 200 kHz, to the washing liquid L of the washing tank 2 from the bottom wall 2a of the washing tank 2.

Furthermore, the flow-through washing apparatus 1 is provided with a pump 8 that sucks the washing liquid L discharged from the discharge ports 5 and feeds the washing liquid L to the feed ports 3 again with pressure, and a filter 9 that purifies the washing liquid L fed with pressure by the pump 8, as a device that is used to cyclically reuse the washing liquid L flowing in the washing tank 2.

A flow-through washing method to which the invention is applied washes the plurality of substrates W, which are held on the holder 50, by the flow-through washing apparatus 1 having the above-mentioned configuration. Specifically, in the flow-through washing method using the flow-through washing apparatus 1, washing liquid L is made to flow in a laminar flow state in the lateral direction (horizontal direction) in the immersion space S of the washing tank 2, and the holder 50 holding the plurality of substrates W is immersed in the washing liquid L in the immersion space S whilst ultrasonic vibration is applied to the washing liquid L.

At this time, the main surfaces of the respective substrates W held on the holder 50 are parallel to the flow direction of the washing liquid L in the washing tank 2 and washing liquid L flows between these respective substrates W in a laminar flow state. Accordingly, the surfaces of the respective substrates W are washed by the washing liquid L, so that contaminants, such as dust and foreign materials, adhering to the surfaces of the respective substrates W are removed.

Meanwhile, the following was found by the inventor's analysis. That is, when ultrasonic vibration is applied to the washing liquid L from the bottom of the washing tank 2, the surface of the washing liquid L in the washing tank 2 is raised, so that the washing liquid L flowing in the washing tank 2 forms turbulent flows and the washing performance for the substrate W deteriorates.

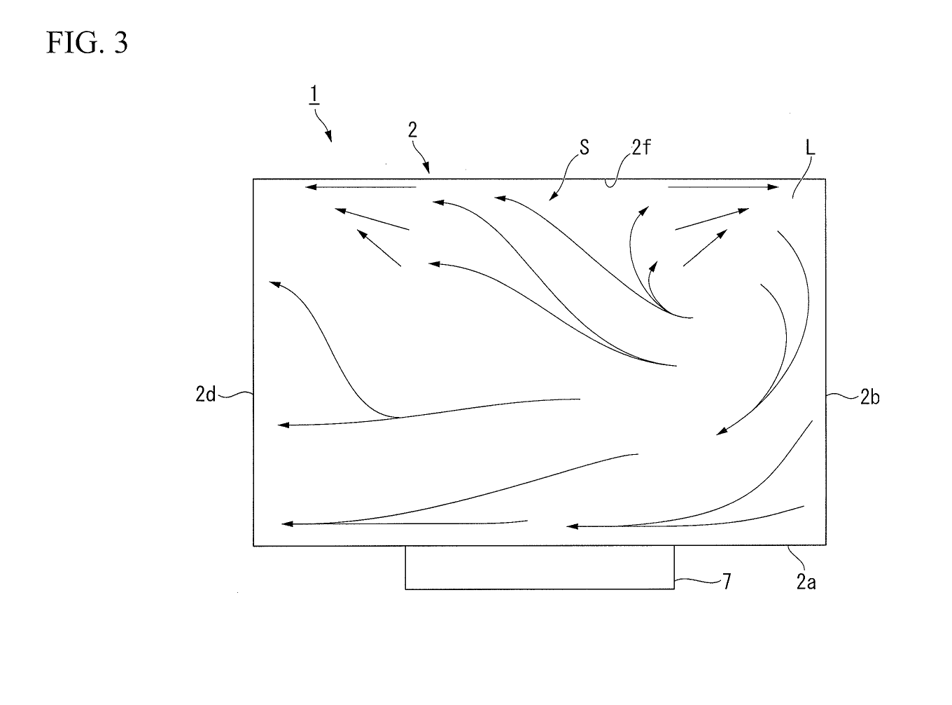

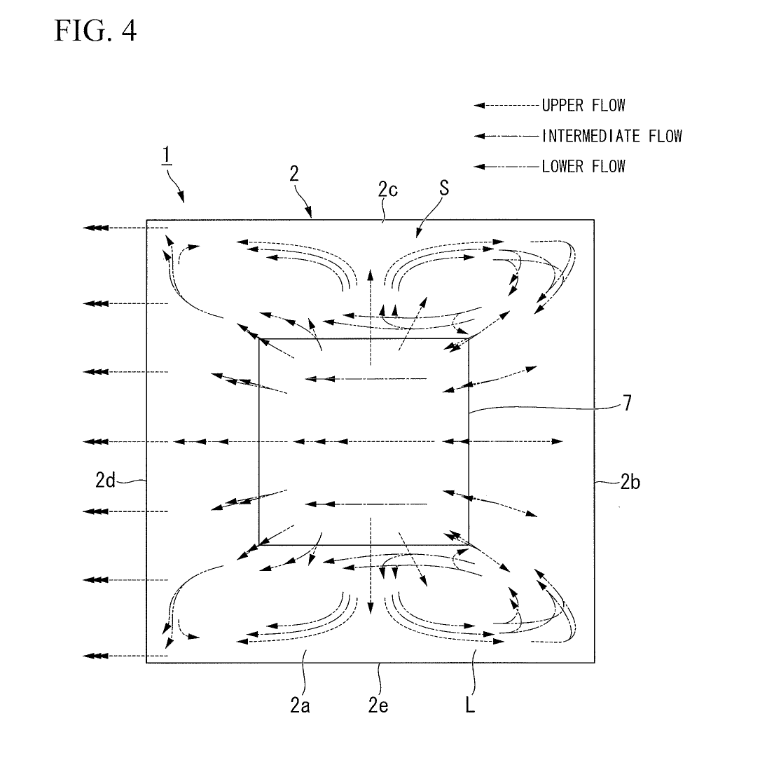

Specifically, according to the inventor's analysis, washing liquid L is made to flow in a laminar flow state in the washing tank 2 whilst ultrasonic vibration is not applied. Then, when ultrasonic vibration is applied, the flows of the washing liquid L raise the surface of the washing liquid L in the washing tank 2 as shown in the directions of arrows shown in FIG. 3 by the application of ultrasonic vibration from the bottom of the washing tank 2 and the raised washing liquid L is dispersed in all directions. However, since laminar flows are applied to the flows of the washing liquid L, complicated flows (turbulent flows) are generated in the washing tank 2. Moreover, when the substrates W are immersed in the washing tank 2, the washing liquid L flowing in the washing tank 2 is disturbed by the substrates W and forms turbulent flows as shown in FIG. 4. Washing performance for the substrate W deteriorates due to the turbulent flows.

Meanwhile, FIG. 3 is a view showing the flows of the washing liquid L in a case where ultrasonic vibration is applied to the inside of the washing tank 2, when the washing tank 2 is seen from the lateral side. On the other hand, FIG. 4 is a view where the upper flows of the washing liquid L flowing in the washing tank 2 are shown by a broken line, the intermediate flows of the washing liquid are shown by a dashed-dotted line, and the lower flows of the washing liquid are shown by a two-dot chain line, when the washing tank 2 is seen from the upper side.

In the invention, as shown in FIGS. 1 and 2, whilst the above-mentioned flow rate regulating valves 4 and 6 are controlled, the flow rate of the washing liquid L flowing through one of the feed ports 3 and/or the discharge ports 5 is regulated and the flow of the washing liquid L in the washing tank 2 is regulated so that the flow of the washing liquid L becomes a uniform flow (laminar flow) without disturbance to the flow of the washing liquid L.

Accordingly, it is possible to make the washing liquid L in the washing tank 2 flow in a laminar flow state from a turbulent flow state. In particular, since the flow rate of the washing liquid L discharged from the discharge ports 5 in addition to the flow rate of the washing liquid L supplied from the feed ports 3 are controlled by the flow rate regulating valves 4 and 6 in the invention, it is possible to form laminar flows in the washing tank 2 with more controllability. Therefore, it is possible to prevent laminar flows from being disturbed by ultrasonic vibration or the disposition of an object W to be washed.

Furthermore, in the invention, it is preferable that the washing liquid L flowing in the washing tank 2 be cyclically reused as in the flow-through washing apparatus 1. Accordingly, it is easy to make the flow rate of the washing liquid L to be supplied to the washing tank 2 balance with the flow rate of the washing liquid L to be discharged from the washing tank 2, so that it is possible to make the washing liquid L, which flows in the washing tank 2, more stably flow in a laminar flow state.

Meanwhile, in the case of the flow-through washing apparatus 1, the amount of the washing liquid L is slightly reduced due to evaporation or the like of the washing liquid L from the opening portion 2f of the washing tank 2. For this reason, it is preferable that washing liquid L corresponding to the reduced amount be appropriately replenished. Moreover, in the flow-through washing apparatus 1, a lid may be provided at the opening portion 2f of the washing tank 2 in order to prevent bubbles from being mixed to the washing liquid L due to the contact between the washing liquid L and air.

Furthermore, in the invention, it is preferable that the interval between the plurality of substrates W held on the holder 50 be reduced to the range where the resistance of the washing liquid L flowing between the substrates is increased when the plurality of substrates W, which are held in line on the above-mentioned holder 50 so as to be parallel to each other, are washed.

For example, when pure water is used as the washing liquid L and substrates for disk-shaped magnetic recording media each having a diameter of 3.5 inches and a thickness of 1.27 mm are washed as the substrates W, the resistance of flowing washing liquid begins to significantly increase in the vicinity of the interval range where the interval between the surfaces of the substrates is equal to or smaller than 10 mm.

Meanwhile, in the flow-through washing method in the related art, it was general that objects to be washed, which are to be disposed in the washing tank 2, are sparsely disposed at intervals and spaces are formed around the objects disposed in the washing tank for the purpose of the stabilization of the laminar flows of the washing liquid flowing in the washing tank 2. The reason for this is to stabilize the laminar flows of the washing liquid L flowing in the washing tank by reducing the distribution of resistance of flowing washing liquid that depends on the presence or absence of the objects to be washed in the washing tank.

In contrast, in the flow-through washing method of the invention, the substrates W (objects to be washed) are closely disposed in the washing tank 2, so that the resistance of the washing liquid L flowing in the washing tank 2 is increased and the state of the washing liquid is made uniform. Accordingly, it is possible to stabilize the laminar flows of the washing liquid L flowing in the washing tank 2 and to increase the washing performance of the washing tank 2.

Furthermore, in the invention, it is preferable that the shortest distance between the substrate W and the inner surface of the washing tank 2 be set to one time or less of the diameter of the substrate W. In particular, in the invention, when the substrates W for disk-shaped magnetic recording media are to be washed as objects to be washed, it is possible to accurately and efficiently wash the substrates W by disposing the substrates W in the washing tank 2 so that the main surfaces of the substrates W are parallel to the flow direction of the washing liquid L, setting the shortest distance between each of the substrates W and the inner surface of the washing tank 2 to one time or less of the diameter of the substrate W.

In this way, it is possible to perform advanced substrate washing that efficiently removes dust and the like adhering to the surface of the substrate and prevents the dust and the like from adhering to the surface of the substrate again after washing.

Although the invention is not necessarily limited to the above-mentioned embodiment, various modifications may be made without departing from the scope of the invention.

For example, the holder 50 has been adapted to support the outer peripheral portion of each substrate W at two points by the pair of support plates 51a and 51b, but is not limited thereto. The positions and the number of points where each substrate W is supported may be appropriately changed in the embodiments. For example, the outer peripheral portion of each substrate W may be supported at three or four points.

Further, members which support the outer peripheral portion of each substrate W are also not limited to the above-mentioned support plates 51a and 51b. As long as the members for supporting each substrate do not disturb the flow of the washing liquid L flowing in the washing tank 2, the shape and the like of the member may be appropriately changed in embodiments.

Furthermore, the invention may be applied to the washing of a magnetic recording medium, for example, on which a magnetic film or the like has been formed or a lubricant is not yet applied, other than a process for removing dust, foreign materials, and the like adhering to the surface of the above-mentioned substrate W for a magnetic recording medium after a surface treatment process and the like.

In addition, the invention may be preferably used when a flat object to be washed is washed as well as when the above-mentioned substrate W for a magnetic recording medium is washed. However, as long as an object to be washed can be washed by the flow-through washing apparatus 1, the object to be washed is not particularly limited.

### EXAMPLES

Hereinafter, the effect of the invention will be made clear by Examples. Meanwhile, the invention is not limited to the following Examples, and may be modified in embodiments without departing from the scope of the invention.

### Example 1

In Example 1, a test was performed to change the flows of washing liquid L in a washing tank 2 to laminar flows by actually regulating the flow rate of the washing liquid L flowing through feed ports 3 and discharge ports 5 by flow rate regulating valves 4 and 6 when complicated flows (turbulent flows) were generated in the washing tank 2 as shown in FIG. 3 by the application of ultrasonic vibration from the bottom of the washing tank 2.

Specifically, the washing tank 2, which was made of SUS304 and had a length of 40 cm, a width of 40 cm, and a depth of 35 cm, was used. Whilst facing each other, the feed ports 3 and the discharge ports 5, each of which had a diameter of 15 mm, were formed at side walls 2b and 2d of the washing tank 2, respectively. Lines each of which were formed of three ports disposed in line at an interval of 55 mm in the height direction and lines each of which was formed of two ports disposed in line at an interval of 60 mm in the height direction were alternately disposed at an interval of 145 mm in a width direction so as to form nine lines, that is, 23 ports (=3×5+2×4) in total were disposed in zigzags and connected to the flow rate regulating valves 4 and 6, respectively. Furthermore, an ultrasonic oscillator 7, which had a frequency of 950 kHz and an output of 600 W, was disposed on the outside of the bottom of the washing tank 2. A 0.5 micron filter was used as a filter 9 at the first stage and washing liquid L flowing in the washing tank 2 was cyclically reused. Furthermore, pure water was used as the washing liquid L and the temperature of the pure water was set to 23±3° C.

Moreover, the washing liquid L was made to flow in the lateral direction in a laminar flow state in the washing tank 2. Furthermore, whilst ultrasonic vibration was applied to the washing liquid L, the respective flow rate regulating valves 4 and 6 were regulated so that the washing liquid L flowed from each of the feed ports 3 and the discharge ports 5 at a rate of 40 liters/minute.

Here, the washing liquid L was not circulated from the downstream side wall 2d of the washing tank 2 due to overflow and discarded at a rate of 5 liters/minute. Meanwhile, the speed of the washing liquid L flowing in the washing tank 2 at this time was about 14 mm/sec. In accordance with this, the respective flow rate regulating valves 4 and 6 were regulated so that the flow rate of the washing liquid L discharged from the upper discharge ports 5 was set to 20 liters/minute and washing liquid L was newly supplied from the upper feed ports 3 at a rate of 5 liters/minute.

Accordingly, it was possible to prevent the back flow that was caused by the raised surface of the washing liquid L in the above-mentioned washing tank 2. That is, it was confirmed that it was possible to effectively ease turbulent flows, which were generated at the upper portion of the washing tank 2, by regulating the supply of washing liquid L from the feed ports 3 formed at the upper portion of the washing tank 2 and the discharge of the washing liquid L from the discharge ports 5.

### Example 2

In Example 2, substrates W were actually washed by the flow-through washing apparatus 1 shown in FIGS. 1 and 2.

Specifically, the washing tank 2, which was made of SUS304 and had a length of 40 cm, a width of 40 cm, and a depth of 35 cm, was used. Whilst facing each other, the feed ports 3 and the discharge ports 5, each of which had a diameter of 15 mm, were formed at the side walls 2b and 2d of the washing tank 2 in seven lines at an interval of 5 cm in the width direction and in six lines at an interval of 5 cm in the height direction, respectively, that is, 42 ports (=7×6) in total were disposed in the form of a lattice and connected to the flow rate regulating valves 4 and 6, respectively. Furthermore, an ultrasonic oscillator 7, which had a frequency of 950 kHz and an output of 600 W, was disposed on the outside of the bottom of the washing tank 2. A 0.5 micron filter was used as a filter 9 at the first stage and washing liquid L flowing in the washing tank 2 was cyclically reused.

Furthermore, test pieces (disk-shaped substrates each having an outer diameter of 50 mm and a thickness of 3 mm), to which powder having a diameter of 1 to 50 micron was stuck and which were used for the evaluation of washing performance, were prepared as objects W to be washed. These substrates were held on the holder 50 whilst being arranged at an interval of 10 mm in five lines (395 test pieces in total) in a direction perpendicular to main surfaces so that 39 test pieces were arranged per line. Then, the holder 50 was disposed on the bottom of the washing tank 2 so that the main surfaces of the substrates W were parallel to the flow direction of the washing liquid L. Furthermore, whilst the washing liquid L was made to flow in the lateral direction in a laminar flow state and ultrasonic vibration was applied to the washing liquid L in a state where the holder 50 was immersed in the washing liquid L in the washing tank 2, the substrates were washed for 10 minutes. Furthermore, pure water was used as the washing liquid L and the temperature of the pure water was set to 23±3° C.

Furthermore, the flow rate of the washing liquid L flowing through each of the feed ports 3 and the discharge ports 5 was regulated whilst the openings of the flow rate regulating valves 4 and 6 connected to the feed ports 3 and the discharge ports 5 were regulated so that the average speed of the flow of the washing liquid L (the speed of the flow of the washing liquid in the state where the objects to be washed were immersed and ultrasonic vibration was applied) flowing in the washing tank 2 in a laminar flow state was 3 m/min.

Specifically, in Example 2, the openings of the flow rate regulating valves 4 and 6, which were connected to the feed ports 3 and the discharge ports 5, respectively, were regulated as shown in Table 1. Meanwhile, Table 1 shows the openings (%) of the valves corresponding to 42 ports, that is, the feed ports 3 and the discharge ports 5 arranged in the width direction and the height direction when the upstream and downstream side walls 2b and 2d are seen from the inside of the washing tank 2 (Table 2 to be described below is the same as described above).

TABLE 1
Opening (%) of valve corresponding to feed port

| | | | | | | |
|---|---|---|---|---|---|---|
| 85 | 80 | 80 | 70 | 80 | 80 | 85 |
| 80 | 70 | 65 | 60 | 65 | 70 | 80 |
| 70 | 60 | 50 | 50 | 50 | 60 | 70 |
| 60 | 55 | 50 | 50 | 50 | 55 | 60 |
| 60 | 50 | 50 | 50 | 50 | 55 | 60 |
| 60 | 55 | 55 | 55 | 55 | 55 | 60 |

Opening (%) of valve corresponding to discharge port

| | | | | | | |
|---|---|---|---|---|---|---|
| 90 | 85 | 85 | 75 | 85 | 85 | 90 |
| 85 | 80 | 75 | 70 | 75 | 80 | 85 |
| 70 | 60 | 50 | 50 | 50 | 60 | 70 |
| 50 | 50 | 50 | 50 | 50 | 50 | 50 |
| 50 | 50 | 50 | 50 | 50 | 50 | 50 |
| 50 | 50 | 50 | 50 | 50 | 50 | 50 |

### Comparative Example 1

In Comparative Example 1, substrates W were actually washed by the flow-through washing apparatus 1 shown in FIGS. 1 and 2 like in like Example 2. As shown in Table 2, test pieces W were washed in the same manner as Example 2 except that the openings of the valves corresponding to the feed ports 3 and the discharge ports 5 were not regulated.

TABLE 2
Opening (%) of valve corresponding to feed port

| | | | | | | |
|---|---|---|---|---|---|---|
| 50 | 50 | 50 | 50 | 50 | 50 | 50 |
| 50 | 50 | 50 | 50 | 50 | 50 | 50 |
| 50 | 50 | 50 | 50 | 50 | 50 | 50 |
| 50 | 50 | 50 | 50 | 50 | 50 | 50 |
| 50 | 50 | 50 | 50 | 50 | 50 | 50 |
| 50 | 50 | 50 | 50 | 50 | 50 | 50 |

Opening (%) of valve corresponding to discharge port

| | | | | | | |
|---|---|---|---|---|---|---|
| 50 | 50 | 50 | 50 | 50 | 50 | 50 |
| 50 | 50 | 50 | 50 | 50 | 50 | 50 |
| 50 | 50 | 50 | 50 | 50 | 50 | 50 |
| 50 | 50 | 50 | 50 | 50 | 50 | 50 |
| 50 | 50 | 50 | 50 | 50 | 50 | 50 |
| 50 | 50 | 50 | 50 | 50 | 50 | 50 |

Furthermore, the ratio of powder remaining on the test piece W after washing was evaluated about Example 2 and Comparative Example 1. As a result, the average powder removal rate was about 96.5% in Comparative Example 1. Meanwhile, the average powder removal rate was about 99.7% in Example 2, and it was found that the washing performance in Example 2 was superior to the washing performance in Comparative Example 1.

### REFERENCE SIGNS LIST

1: FLOW-THROUGH WASHING APPARATUS
2: WASHING TANK
3: FEED PORT
4: FLOW RATE REGULATING VALVE (FLOW RATE REGULATING DEVICE)
5: DISCHARGE PORT
6: FLOW RATE REGULATING VALVE (FLOW RATE REGULATING DEVICE)
7: ULTRASONIC OSCILLATOR (VIBRATION GENERATING DEVICE)
8: PUMP
9: FILTER

1. A flow-through washing method comprising steps of:
making washing liquid flow in a lateral direction in a washing tank, and
washing objects to be washed whilst applying ultrasonic vibration to the washing liquid in a state where the objects to be washed are immersed in the washing liquid,
wherein the washing liquid in the washing tank flows in a laminar flow state by regulating the flow rate of the washing liquid flowing through any feed ports and/or discharge ports of a plurality of feed ports through which the washing liquid is supplied to the washing tank and a plurality of discharge ports through which the washing liquid is discharged from the washing tank.

2. The flow-through washing method according to claim 1,
wherein ultrasonic vibration is applied from the bottom of the washing tank.

3. The flow-through washing method according to claim 1,
wherein when substrates, which are held on a holder as the objects to be washed, are washed, the holder is disposed in the immersion tank so that main surfaces of the substrates are parallel to the flow direction of the washing liquid.

4. The flow-through washing method according to claim 3,
wherein a plurality of substrates, which are held in line on the holder so as to be parallel to each other, are washed, and the interval between the plurality of substrates held on the holder is reduced to a range where resistance of the washing liquid flowing between the substrates is increased.

5. The flow-through washing method according to claim 3,
wherein the shortest distance between the substrate and an inner surface of the washing tank is set to one time or less of a diameter of the substrate.

6. The flow-through washing method according to claim 1,
wherein substrates for magnetic recording media or magnetic recording media are washed as the substrates.

7. The flow-through washing method according to claim 1,
wherein the washing liquid is cyclically reused.

8. A flow-through washing apparatus comprising:
a washing tank where objects to be washed are washed,
a plurality of feed ports through which washing liquid is supplied to the washing tank,
a plurality of discharge ports through which the washing liquid is discharged from the washing tank, and
a vibration generating device for applying ultrasonic vibration to the washing liquid in the washing tank,
wherein the flow-through washing apparatus makes the washing liquid flow in the lateral direction in the washing tank and washes objects to be washed whilst applying ultrasonic vibration to the washing liquid in a state where the objects to be washed are immersed in the washing liquid, and
the flow-through washing apparatus further comprises:
a flow rate regulating device for regulating the flow rate of the washing liquid flowing through any feed ports and/or discharge ports.

9. The flow-through washing apparatus according to claim 8,
wherein the vibration generating device is disposed on the bottom of the washing tank.

10. The flow-through washing apparatus according to claim 8, further comprising:
a device that circulates the washing liquid.

11. A method of manufacturing a magnetic recording medium, comprising:
(i) a step of forming at least a magnetic layer on a substrate to providing a substrate having at least magnetic recording layer and
(ii) at least one of steps of
cleaning the substrate by the flow-through washing method according to claim 1 before the step (i), and
cleaning the substrate having at least magnetic recording layer by the flow-through washing method according to claim 1 after the step (i).

12. A method of manufacturing a magnetic recording medium, comprising:
(i) a step of forming at least a magnetic layer on a substrate to providing a substrate having at least magnetic recording layer and
(ii) at least one of steps of
cleaning the substrate by using the flow-through washing apparatus according to claim 8 before the step (i), and
cleaning the substrate having at least magnetic recording layer by using the flow-through washing apparatus according to claim 8 after the step (i).
